(19) United States
(12) Patent Application Publication
(10) Pub. No.: US 2010/0319502 A1
(43) Pub. Date: Dec. 23, 2010

(54) PARTS MANUFACTURING METHODS, SYSTEMS AND USES

(75) Inventor: Arthur Harrison, Milton (CA)

Correspondence Address: LAW OFFICE OF DELIO & PETERSON, LLC., 121 WHITNEY AVENUE, NEW HAVEN, CT, 06510, US

(73) Assignee: 2SOURCE MANUFACTURING INC., Mississauga (CA)

(21) Appl. No.: 12/816,668

(22) Filed: Jun. 16, 2010

Related U.S. Application Data
(60) Provisional application No. 61/218,403, filed on Jun. 18, 2009.
(60) Provisional application No. 61/345,266, filed on May 17, 2010.
(60) Provisional application No. 61/355,178, filed on Jun. 16, 2010.

(51) Int. Cl. B23B 1/00; B23B 5/00; B23B 7/00; B23B 31/40

(52) U.S. Cl. 82/1.11; 82/155; 82/117; 244/100 R; 82/118

(57) ABSTRACT

A method for manufacturing a part selected from a plurality of part types is disclosed. The method involves the step of selecting, from a supply of workpieces, a workpiece of a type that is associated with the type of part selected, the workpiece having a void and a substantially annular outer surface. Using a lathe, the selected workpiece is machined into the selected part. The workpiece, during the machining step, is mounted to the lathe by a collet associated with the type of part selected. The collet is an expanding collet which, during machining, is received by the void and engages the workpiece in gripping relation. The part can be a bushing for an aircraft landing gear and the workpiece can be an oversized bushing. The method can be carried out at an aircraft repair facility and the oversized bushings can be procured from specialist fabricators.

### FIELD OF THE INVENTION

The present invention relates to the field of precision machining.

### BACKGROUND OF THE INVENTION

Precision machining plays an important role in the field of aircraft maintenance, as the proper maintenance of aircraft is a matter of utmost importance for safety and operation.

One area of interest from the standpoint of aircraft maintenance is landing gear maintenance. Because of the significant stresses which landing gear experience, it is commonplace to regularly refurbish landing gear. This normally involves the removal and replacement of all of the bushings. Since, in some aircraft, there can be upwards of 1000 bushings in the landing gear, this can represent a significant undertaking and cost.

Historically, this replacement has often been done as part of a fairly laborious process. As each bushing is removed, the associated bore is inspected for corrosion. If corrosion is found in or around the bore, that corrosion is precisely machined away. Measurements are taken of each bore. With these measurements, a replacement bushing is custom-machined on site from the appropriate material and then plated or otherwise processed, all according to the appropriate maintenance standards.

### SUMMARY OF THE INVENTION

A method for manufacturing a part forms one aspect of the invention. This method is for use with a lathe and comprises the steps of:
making an arrangement of (i) an expanding collet which is operatively mounted on said lathe and disposed in a rest configuration and (ii) a workpiece in which a void is formed and which has a substantially annular outer surface, the arrangement being such that the collet is received by the void and the workpiece being shaped and dimensioned such that, in the arrangement, the collet is received by the void in a clearance fit relation and the rotational axis of the lathe is substantially coaxial with the annular outer surface of the workpiece;
expanding the collet to an operating configuration in which the collet engages said workpiece in gripping relation;
machining said workpiece into said part, using the lathe; and
collapsing the collet to the rest configuration, to enable removal of said part from the collet.

A method for manufacturing a part selected from a plurality of part types forms another aspect of the invention. This method is for use with a lathe and comprises the steps of:
selecting, from a supply of workpieces, a workpiece of a type that is associated with the type of part selected, the workpiece having a void and a substantially annular outer surface; and
using the lathe, machining the selected workpiece into the selected part, the workpiece, during the machining step, being mounted to the lathe by a collet associated with the type of part selected,
wherein the collet is an expanding collet which, during machining, is received by the void and engages the workpiece in gripping relation.

According to other aspects of the invention, in the latter method:
the collet can have the expanded operating configuration during machining and can also have a collapsed rest configuration, to enable removal of said part after machining;
a plurality of expanding collets can be provided; and
each of the expanding collets can have a functionally identical mounting boss to facilitate interchange on the lathe.

A system for producing replacement bushings for a landing gear using a lathe forms another aspect of the invention. Each bushing has an associated bore in the landing gear and, when originally manufactured, is classifiable, by its dimensions, into one of a plurality of bushing types, each bushing type having a central void, a nominal external diameter and a flange thickness. The system comprises oversized bushings and collets. Each oversized bushing is for replacement of one or more of the bushing types to be replaced using the system and has a central void shaped and dimensioned substantially identical to that of each of said one or more bushing types, a nominal external diameter larger than that of each of said one or more bushing types and a flange thickness larger than that of each of said one or more bushing types. Each expanding collet is provided for use with one or more of said bushing types and, in use, is mounted on said lathe and disposed in gripping relation within the void of one of the oversized bushings, with the rotational axis of the lathe substantially coaxial with the axis of the oversized bushing.

According to another aspect of the invention, the central voids of the oversized bushings can be annular.

According to another aspect of the invention, the system can further comprise facsimile bushings, each facsimile bushing being for replacement of one of the bushing types to be replaced using the system, each facsimile bushing having nominal internal and external diameters and flange thicknesses functionally similar to those of said one bushing type but otherwise different.

The system can be used, along with a lathe, in a method for producing replacement bushings for a landing gear wherein each of the bushings to be replaced have been removed from the landing gear and the associated bores reconditioned as necessary.

The method comprises the steps of:
in circumstances wherein the dimensions of the bore associated with said each removed bushing remain as originally manufactured, using one of the facsimile bushings provided for the type of said each removed bushing; and
in circumstances wherein the dimensions of the bore associated with said each removed bushing differ from those as originally manufactured,
   ∘ operatively mounting, to said lathe, one of the oversized bushings provided for replacement of type of said each removed bushing, the mounting being done through the use of the collet provided for the type of said each removed bushing; and
   ∘ machining the oversized bushing mounted on said lathe to fit operably in the bore associated with said each removed bushing.

The system can also be used, along with a lathe, as part of another method for producing replacement bushings for a landing gear, wherein each of the bushings to be replaced have been removed from the landing gear and the associated bores reconditioned as necessary.

This method comprises the steps of:
operatively mounting, to said lathe, one of the oversized bushings provided for replacement of type of said each removed bushing, the mounting being done through the use of the collet provided for the type of said each removed bushing; and
machining the oversized bushing mounted on said lathe to fit operably in the bore associated with said each removed bushing.

According to other aspects of the invention, the method can be used
for manufacturing bushings for aircraft landing gear;
wherein the workpiece is an oversized bushing; and
wherein the workpiece is a partially-machined bushing.

Aircraft landing gear bushings made by the method form another aspect of the invention.

According to other aspects of the invention, the system can further comprise: a CNC lathe with a dimensional measurement tool; a data handling tool coupled to the lathe to permit passage of data and instructions; and an electronic measurement device coupled to the data handling tool to permit passage of data therebetween.

The system which further comprises a CNC lathe can, according to another aspect of the invention, be used in a method for producing replacement bushings for an aircraft landing gear, wherein each of the bushings to be replaced have been removed from the landing gear and the associated bores reconditioned as necessary. This method comprises the steps of:
for each bushing:
   ∘ at least in circumstances wherein the dimensions of the bore associated with said each removed bushing differ from those as originally manufactured,
      measuring the dimension of the bore with the electronic measurement device;
      operatively mounting, to said lathe, one of the oversized bushings provided for replacement of the type of said each removed bushing, the mounting being done through the use of the collet provided for the type of said each removed bushing; and
      machining the oversized bushing mounted on said lathe to fit operably in the bore associated with said each removed bushing.

According to another aspect of the invention, the data handling tool can automatically: cause the display to the lathe operator of information used by the lathe operator to select the collet and the oversized bushing; calculate the required machined dimensions of the bushing based on the measured dimensions of the bore, predetermined interference requirements and predetermined coating thickness; and relay to the lathe the required dimensions.

According to another aspect of the invention, the lathe can automatically machine the oversized bushing according to a protocol calculated to result in the required dimensions.

According to another aspect of the invention, prior to machining, the dimensional measurement tool can automatically measure the dimensions of the collet and oversized bushing to permit the operator to effect replacement in the event that an error was made by the operator in the course of selection.

According to another aspect of the invention, following machining: the dimensional measurement tool can automatically measure the dimensions of the machined bushing; the measured dimensions can be automatically compared against the required dimensions; the data handling tool can offer the opportunity to the operator to offset the lathe an amount calculated to reduce the differentials between required and measured dimensions to nil; and, in the event that the comparison is reflected in measured dimensions that are outside predetermined tolerance and in excess of required dimensions, the lathe, after offset has occurred, can automatically carry out a machining operation according to a protocol calculated to result in the required dimensions.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1 shows a prior art aircraft landing gear bushing;

FIG. 2 shows exemplary components of the system of the present invention according to an exemplary embodiment;

FIG. 3 shows the structure of encircled area 3 of FIG. 2 along with a further exemplary embodiment of this structure;

FIG. 4 shows the structures of FIGS. 2 and 3, along with another exemplary embodiment of the structure of encircled area 4 of FIG. 2;

FIG. 5 shows the structures of FIG. 4 fitted together;

FIG. 6 shows the structure of encircled area 4 of FIG. 2 operatively mounted to a CNC lathe;

FIG. 7 shows the structure of encircled area 3 of FIG. 2 operatively mounted to the structure of FIG. 6;

FIG. 8 is an underside view of the structure of encircled area 4 of FIG. 2;

FIG. 9 is a view of a further exemplary embodiment of the structure of encircled area 4 of FIG. 2; and

FIG. 10 is a view of the structure of FIG. 9 disassembled.

### DETAILED DESCRIPTION

As indicated, the present invention relates, in part, to a system for producing replacement bushings for a landing gear using a lathe. An exemplary embodiment of the system is hereinafter described in detail, but as an initial matter, it should firstly be understood that each bushing has an associated bore in the landing gear and, when originally manufactured, is classifiable, by its dimensions, within one of a plurality of bushing types, each bushing type having a nominal internal diameter, a nominal external diameter and a flange thickness.

A “nominal” diameter in this specification should be understood to mean a diameter which exists at a plurality of locations along the part, but not necessarily all locations along the part, i.e. allowing for structures such as lubrication channels and holes, grooves, slots, etc.

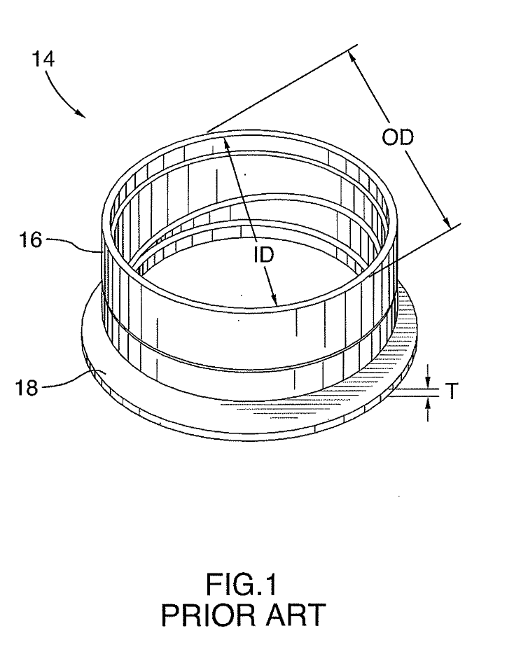

For reference, an exemplary bushing, which forms no part of the invention, is shown in FIG. 1 and identified with general reference numeral 14. The bushing body is indicated with reference numeral 16 and its flange is indicated with reference 18. ID, OD are as shown, and the flange thickness is indicated by T.

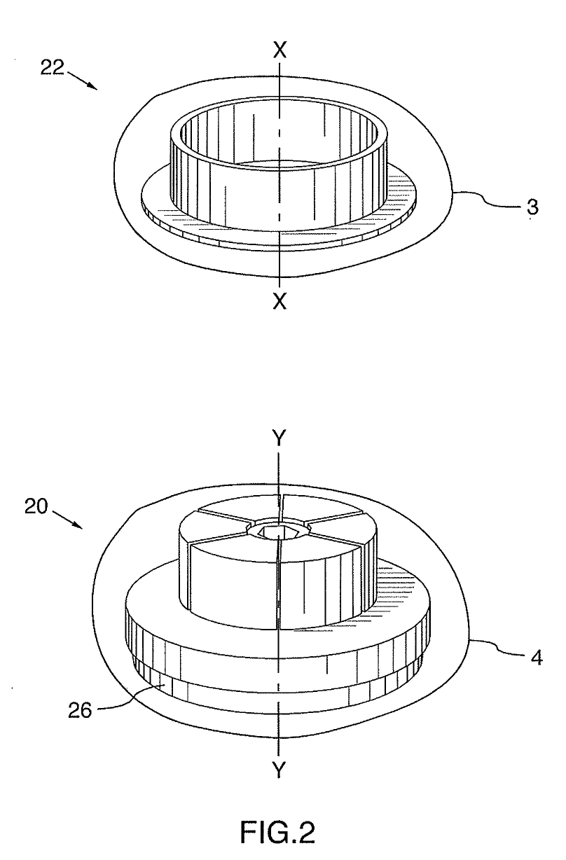

Turning now to the system, it should be understood to comprise collets and oversized bushings, examples thereof being shown in FIG. 2 as 20 and 22, respectively.

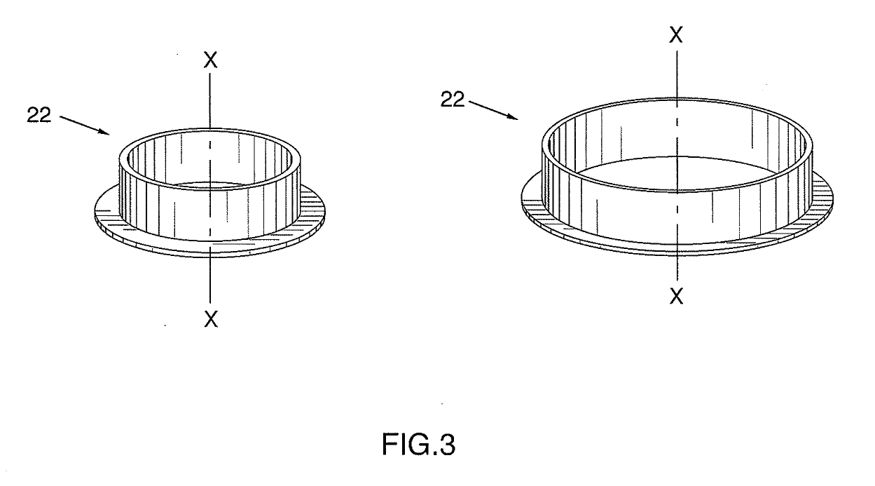

The oversized bushings are provided for each of the bushing types to be replaced using the system. By way of example, only, a pair of oversized bushings is shown in FIG. 3. Although each bushing is clearly dimensioned differently, each is indicated by the same reference numeral 22, as they are functionally similar. “Functionally similar” in this context means that each bushing serves a similar purpose in use, notwithstanding that, in use, the bushings are deployed in different bores in the aircraft.

Each oversized bushing 22 has a nominal internal diameter substantially equal to that of said each bushing type, a nominal external diameter larger than that of said each bushing type and a flange thickness larger than that of said each bushing type. The oversized bushings 22 have an axis indicated as X-X.

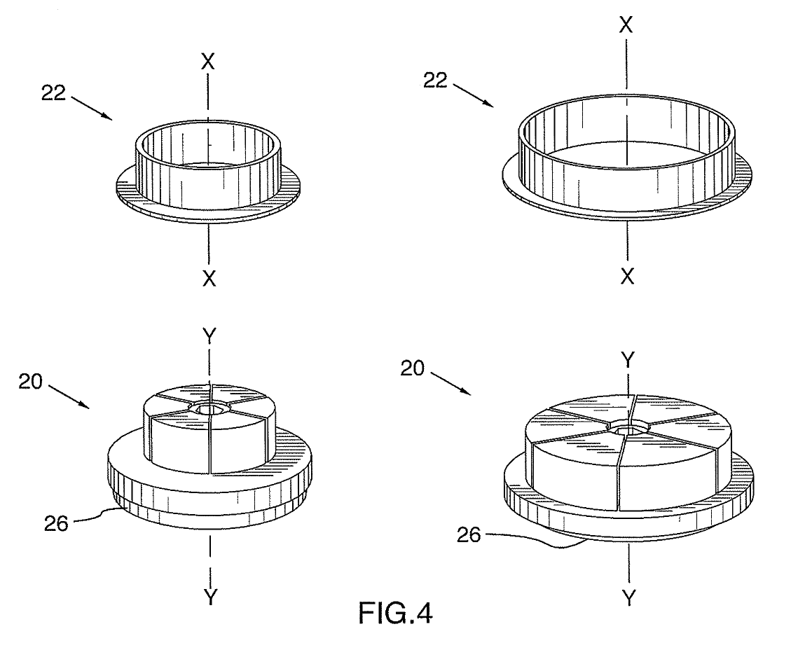

The expanding collets 20 are provided one for each of the bushing types to be replaced by the system and each have an axis indicated as Y-Y. By way of example, only, the oversized bushings 22 of FIG. 3 are shown with a pair of collets 20 for use therewith in FIG. 4. For similar reasons as outlined previously, these collets are indicated with the same reference numeral 20.

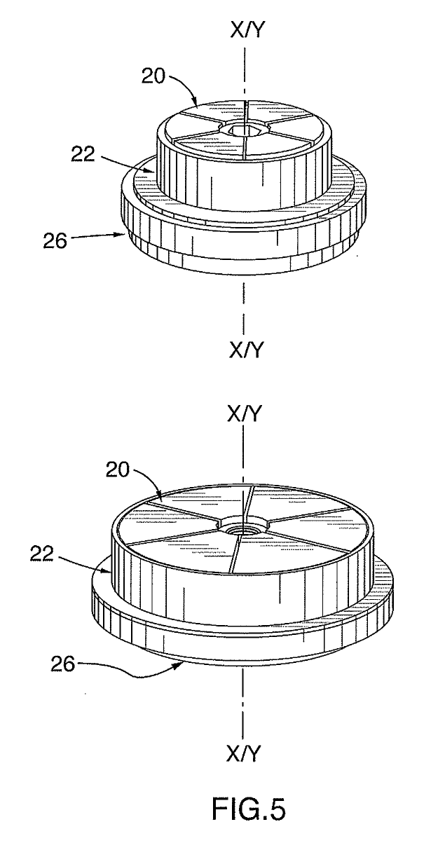

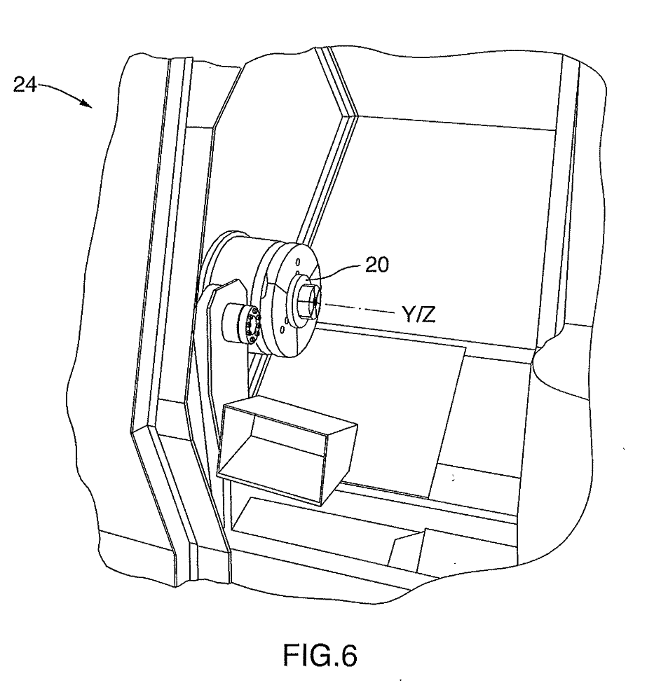

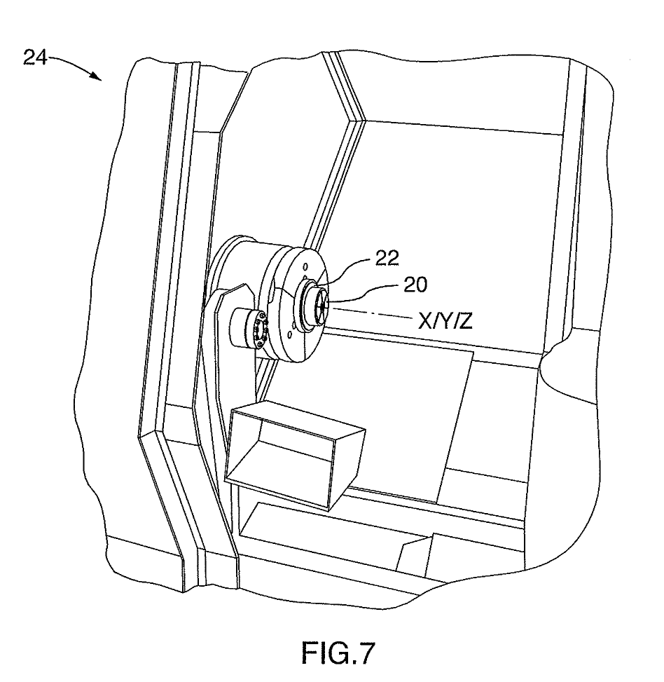

Each expanding collet 20 has a rest configuration, for receiving an oversized bushing 22 of the type for which it is provided in a clearance fit relation, as shown in FIG. 5, such that axes X-X and Y-Y are aligned, and, in use, is mounted on a lathe and disposed in gripping relation within one of the oversized bushings 22 with which said each collet 20 is for use, with the rotational axis Z-Z of the lathe substantially coaxial with the axis X-X of the oversized bushing. A collet 20 is shown mounted to a lathe 24 in FIG. 6, and an oversized bushing 22 is shown mounted to the collet 20 in FIG. 7.

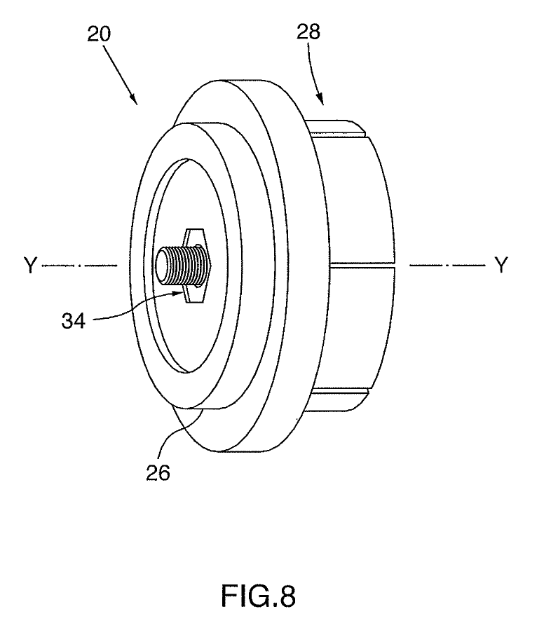

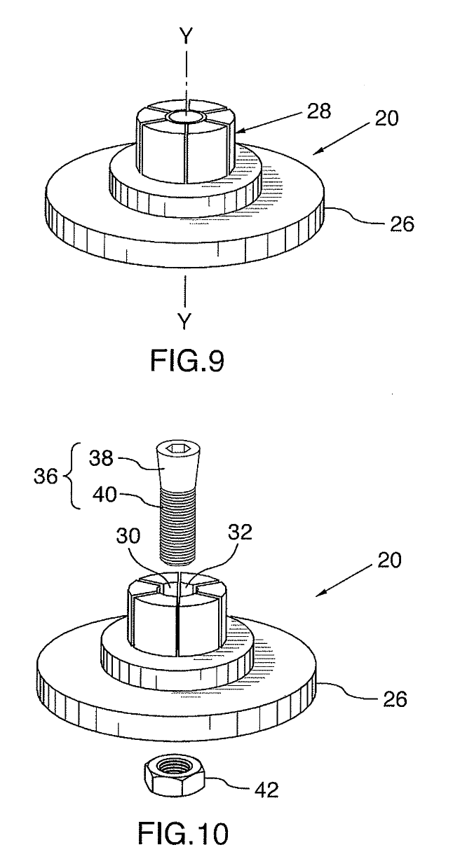

To provide this functionality, the collets 20 are provided with a mounting boss or plate and a longitudinally segmented cylindrical extension protruding from the mounting boss. In FIG. 8, wherein the collet 20 of FIG. 2 is shown upended, these features are indicated respectively by 26 and 28. A further collet 20 is shown in FIG. 9, and shown again disassembled in FIG. 10, and herein it will be seen that the interior surface of the extension 28 has a throughbore 30. One end of the throughbore ends in a frustoconical cavity 32, indicated in FIG. 10, and at the other end in a hexagonal socket 34, indicated in FIG. 8. Returning again to FIG. 10, a bolt 36 is shown. This bolt 36 has a frustoconical head 38 and a threaded shaft 40, the head 38 being of similar dimensions to the cavity 32.

In use, bolt 36 is fitted in the throughbore 30 and is threaded into a nut 42 which is disposed in gripped relation inside the hexagonal socket 34. Thus, rotation of the bolt 36 causes the diameter of the extension 28 to expand. The dimensions of the cylindrical extensions of the collets will be seen to vary, but it will be seen that in each of the expanding collets, the dimensions of the mounting boss 26 remains unchanged.

The bolt 36 should be rotated only sufficient to cause gripping receipt of the bushing by the collet sufficient to permit safe turning on the lathe; excess rotation will cause the bushing to deform, which will impact negatively on dimensional tolerancing.

Precise machining of each collet so as to engage in a close clearance fit with the oversized bushing type for which it is intended to be used, ensures that the axes are substantially aligned and remain aligned after tightening of the bolt.

There can be also included in the system, for each of the bushing types to be replaced, facsimile bushings, each having nominal internal and external diameters and flange thicknesses functionally similar to those of said each bushing type but otherwise different. As these are conventional, these are not shown, but it would be understood that the prior art bushing in FIG. 1 is representative thereof. “Functionally similar” in this context, means that the facsimile bushing is sufficiently similar in structure as to be safely and legally substituted for the original, notwithstanding that minor deviations may be present.

The system is advantageously used in the refurbishment of landing gears which are known to experience some corrosion.

In preparation to use the system in landing gear overhauls, the clamps of a lathe are machined so as to precisely receive the mounting boss of any selected collet. In this regard, it will be recalled that the mounting bosses on all of the collets are substantially identical, so that once the lathe clamps have been machined to precisely receive one, the clamps have been machined to precisely receive any and all. The manner of machining depends upon the capacities of the repair facility and machining for alignment is a skill that is a matter of routine to persons of ordinary skill herein. As such, detail is neither provided nor required, but it is merely noted that various options are possible: the lathe could have soft jaws, machined to precisely receive the mounting boss; the lathe could have pie jaws, machined to precisely receive the mounting boss; and the mounting boss itself could even be received by or define a collet.

A supply of bushings is also obtained. Even in landing gears which are known to suffer some corrosion, there will normally be portions which suffer no corrosion. In these areas of the gear assembly, there may be procured facsimile bushings each having nominal internal and external diameters and flange thicknesses functionally similar to those of said each bushing type but otherwise different. In areas of the gear assembly which are known to commonly suffer corrosion, oversized bushings according to the system will be procured, as well as collets according to the system for use therewith. For reasons set forth hereinabove, there may also be obtained facsimile bushings, each having nominal internal and external diameters and flange thicknesses functionally similar to those of said each bushing type but otherwise different.

Use of the system involves the performance of a method which itself involves, as an initial step, bushing removal.

This step is followed by reconditioning of the bores in accordance with directives set out by the aircraft manufacturer. Where corrosion is present in a bore, the bore is typically bored out to remove corrosion. Where corrosion is present on the face of the part surrounding a bore, the face is machined smooth until corrosion is removed. The face machining extends at least as far as the flange of the bushing to be received therein, i.e. to provide a smooth receiving surface. In both situations, machining is carried out carefully, to maintain the orientation of the bore and the flange-receiving area surrounding it. The steps associated with reconditioning of a bore and/or the surrounding area form no part of the present invention, and moreover, are known to persons of ordinary skill in the art, and as such, are not hereinafter detailed further.

Where no reconditioning of a bore or surrounding area was required, i.e. the dimensions of the bore associated with said each removed bushing remain as originally manufactured, one of the one or more facsimile bushings [each having nominal internal and external diameters and flange thicknesses functionally similar to those of said each bushing type but otherwise different] for the bushing type within which said each removed bushing was classifiable on manufacture, if available, can be fit into the bore associated with said each removed bushing in a known manner.

Bushing replacement will normally take place after the component in which the bore is defined has been painted, etc. Again, these details are well-known in the industry, and not described herein.

In circumstances wherein bore reconditioning was carried out, or wherein facsimile bushings are not available or have not been procured, a custom bushing will be made that corresponds to the dimensions of the bore. To make such a bushing, the dimensions of the bore are measured and an appropriate oversized bushing [i.e. one of the one or more oversized bushings provided for replacement of the bushing type within which said each removed bushing was classifiable on manufacture] is drawn from the supply.

The operator also selects the collet provided for use with the bushing type within which said each removed bushing was classifiable on manufacture.

The collet is mounted on the lathe by engaging the mounting clamps of the lathe around the mounting boss. As the collet and clamps were both precisely machined, as previously discussed, this precisely aligns the collet with the rotational axis of the lathe Z-Z.

Thereafter, the operator makes an arrangement of the bushing and the collet by sliding the bushing around the collet, and tightens the bolt, such that the collet expands, to grip the bushing. Machining is then carried out to the required dimensions. Once the oversized bushing has been machined to the dimensions required to fit properly in the bore [i.e. after any necessary post-machining processing, such as plating, and with suitable accommodations made to to provide the appropriate interference fit between the completed [machined, plated, etc.] bushing and the completed bore [ground, painted, etc.] the machining operation is stopped. Thereafter, the bushing can be removed from the lathe, by loosening the bolt, and subjected to any further treatment that may be required for use, i.e. plating.

Once all required post-machining treatment has been carried out, the now-completed bushing can be fit, in the conventional manner, into the bore associated with the bushing which it has been manufactured to replace.

Automation Option

In an exemplary arrangement of the system:
the lathe is a CNC lathe with a dimensional measurement tool, i.e. an automated probe;
a data handling tool is provided and coupled to the lathe to permit passage of data and instructions therebetween; and
the tool by which the bore is measured is an electronic measurement tool that is coupled wirelessly to the data handling tool to permit passage of data therebetween.

In this arrangement, the data handling tool can be a fully-functional tablet or laptop type computer, which is pre-programmed with data handling software and coupled to the lathe by the Internet. The software includes a database which includes a set of data for each type of aircraft maintained at the aircraft repair facility in question. Each data set includes type and dimensional data [nominal dimensions, allowable tolerances, required interferences, coating thickness and type] for each bushing in the landing gear of the aircraft, as well as dimensional data for each of the oversized and facsimile bushings provided for that aircraft and for the collets. The type and dimensional data in the database is specific to the requirements and desires of the repair facility; although two facilities may work on identical aircraft, the replacement bushings they may specify can differ, depending upon, inter alia, the capacities of the facility and preferred repair techniques.

The software also includes an order management facility, which manages work order assignments at the repair facility and the type of aircraft associated with each work order.

Using this arrangement, the technician responsible for bore measurement can actuate the data handling tool, which prompts for entry of the work order number. Entry of the work order assignment causes the software to create a table which is automatically populated with details of each bushing to be replaced on the landing gear of interest, i.e. the gear that is being refurbished.

Thereafter, for each bushing to be replaced on the landing gear of interest using the Automation Option, four steps are carried out: Measurement, Bore Comparison, Bushing Procurement and Label Generation.

Measurement Step

In the measurement step, the technician selects, from a list, the bore of interest [for example, medial bore, left strut] and uses the measurement tool to measure the diameter of the bore and the depth of the flange-receiving surface. The measurements are automatically relayed wirelessly from the measurement tool to the data handling tool; the electronic measurement, coupled with the automatic relay of information, minimizes the potentials for measurement and transcription-type errors.

Bore Comparison

The data handling tool compares the measured data against the stored dimensional data associated with the bushing of interest:
if the measured data is within allowable limits, the bore comparison step is concluded
if the measured data is outside allowable limits, the operator is advised accordingly, and prompted to confirm the identifier for the bore being measured. If the operator acknowledges that the bore measured was a bore other than that originally selected from the list, the operator is prompted to select the appropriate bore, and the program recommences the Bore Comparison step. If the operator confirms that the bore measured was the bore originally selected from the list, the deficiency is noted and this bushing/bore combination is handled otherwise than via the Automation Option. For example, if the bore is indicated to be in excess of 60 thousands of an inch larger than nominal, the refitter will contact the OEM for a custom solution.

Bushing Procurement Step

In this step, the data handling tool carries out calculations based on the measured data, the required coating thickness and interference fit and allowable tolerances and determines if a facsimile bushing (pre-machined to standard dimensions, i.e. in the case of a bore without or with only microscopic corrosion) can be used or if a custom-machined bushing is required.

Where a custom bushing is required, the data handling tool transmits to the lathe the dimensions of the bushing to be produced, as well as the appropriate one of the oversized bushings to be skimmed and the collet provided for use with that oversized bushing. The lathe displays this data to permit the operator to draw the appropriate collet and oversized bushing from the supply and operably set same in position on the lathe. The lathe also prompts the operator to signify readiness. When the operator has completed bushing placement and securement, he or she responds to the prompt, i.e. indicates readiness.

On receipt of a readiness signal, an error checking procedure is carried out, wherein the probe of the lathe measures the dimensions of the collet and the bushing. These measurements are compared against data in the database, to ensure that no errors have been made in the selection. In the event of an error, the operator is prompted to make appropriate replacements and enter a new readiness signal, to begin anew the error-checking procedure.

Once the appropriate collet and bushing have been determined to be in position, a machining step is carried out, wherein the lathe carries out necessary machining to skim the bushing to the required dimensions. On completion, the probe of the lathe automatically measures the dimensions of the machined bushing.

On completion of the measurement, a comparison of the measured dimensions against expected dimensions is automatically made by the data handling tool, the operator is advised as to the extent of deviation and the data handling tool offers the opportunity to the operator to offset the lathe an amount calculated to reduce the differentials between required and measured dimensions to nil. In the event that the part produced is outside tolerances, the operator will normally authorize the offset, which will then be carried out automatically by appropriate communication between the data handling tool and the lathe.

The operator will also use his or her skill and judgment to offset the lathe from time to time, even in circumstances where the previous part was produced within tolerances. This skill and judgment falls within the normal skillset of average CNC lathe operators and moreover, forms no part of the present invention, such that detailed description is neither required nor provided.

If the measured dimensions of the machined bushing are outside tolerances, after the lathe has been automatically offset in response to the authorization given by the operator:
if the bushing is larger than allowable tolerances, the part is remachined, i.e. the machining step is started anew; and
if the bushing is smaller than allowable tolerances, the operator is instructed to scrap the part, install a new bushing from the supply and enter a readiness signal, which recommences the bushing procurement step at the error-checking step

If the measured dimensions of the bushing are within tolerances, either after an initial machining or after a re-machining, the operator is instructed to withdraw the part, which completes the bushing procurement step.

Label Generation

Following the Bushing Procurement Step, an inspection sheet, detailing the intended use of the bushing, necessary secondary processing required (i.e. coating) and measured dimensions of the part, is printed and associated with the part, for example, by tagging the part, or placing the part and the inspection sheet in a plastic tray or slide-lock bag. Where facsimile bushings are to be used, labels may also be generated therefor, for process consistency.

### CONCLUSION

Without intending to be bound by theory, it is believed that the systems and methods of the present invention provide substantial advantage over the prior art in that same allow for relatively low cost production of relatively highly-concentric machined parts with relatively high turnaround rates even in situations of relatively low production runs. These benefits can be obtained through the use of the collet system alone, but can be improved upon through the Automation Option, which reduces the skill level required of the on-site operators in terms of calculations and knowledge, and also reduces the requirements for attentiveness on the part of the on-site operators, flowing from the error checking and automated data transfers. All of this opens the door to efficiencies of scale, and commensurate improvements in quality, cost and throughput. Further, in the context of aircraft landing gear refurbishment specifically, a substantial portion of the machining associated with bushing production can be moved from the shop floor to specialist fabricators, i.e. the amount of on-site machining of bushings at an aircraft repair facility can be reduced by adopting the system and using oversized bushings machined elsewhere by specialist fabricators. Reducing the amount of on-site machining at an aircraft landing gear refurbishment facility can also reduce time associated with bushing procurement, with commensurate improvements in facility throughput.

While but a few embodiments of the present invention have been herein shown and described, it will be understood that various changes in, inter alia, size and shape of parts, and steps carried out, may be made.

For example, whereas the previous description focuses on ‘skimming’ of oversized bushings, it should be understood that workpieces other than oversized bushings as described hereinbefore are envisioned. By way of example, in known relatively low-volume bushing manufacturing operations, each bushing is cut in a minimum of two steps. In one of these steps, a billet or tube stock is mounted on a lathe in a conventional manner, and some of the features of the bushing are cut. Thereafter, the partially-machined bushing is removed from the lathe and remounted in reverse. Once this secondary mounting has been completed, which can be quite time intensive, as concentricity must be maintained, additional features can be machined. This same relatively low-volume manufacturer could employ the system by maintaining a variety of expandable collets, each matched to a respective one of the bushings in its parts list. After an order is placed for a small run of bushings of a given type, this manufacturer could fit billets or tube stock on its lathes in a conventional manner to cut some of the features of the bushings; once these features had been completed, instead of laboriously remounting the bushings as previously done, the manufacturer can remount the bushings via the collets to perform additional machining.

Thus, the invention can, in one aspect, be understood more broadly as a method for manufacturing a part, the method being for use with a lathe and comprising the steps of:
making an arrangement of (i) an expanding collet which is operatively mounted on said lathe and disposed in a rest configuration and (ii) a workpiece in which a void is formed and which has a substantially annular outer surface, the arrangement being such that the collet is received by the void and the workpiece being shaped and dimensioned such that, in the arrangement, the collet is received by the void in a clearance fit relation and the rotational axis of the lathe is substantially coaxial with the annular outer surface of the workpiece;
expanding the collet to an operating configuration in which the collet engages said workpiece in gripping relation;
machining said workpiece into said part, using the lathe; and
collapsing the collet to the rest configuration, to enable removal of said part from the collet.

The ‘part’ can, by way of example, only, take the form of a ready-to-use aircraft bushing (for example, in circumstances wherein the bushing does not require plating) or a bushing ‘blank’, which, after plating or other post-machining processing, is ready for use in an aircraft landing gear.

Further, whereas it is contemplated that specific oversized bushings will be provided for each type of bushing to be replaced, this is not strictly necessary: if bushings of very similar but different dimensions were required, it could be determined that the same type of oversized bushing could be used to minimize inventory costs.

Similarly, whereas it is contemplated that a unique expanding collet would be provided for each type of bushing to be replaced, again, if bushings were required that had very similar but different ID bores, it would be possible to use a common expanding collet.

Further, whereas in the exemplary embodiment, the collets shown are all substantially cylindrical, this is not necessary, and depends on the shape of the inner void of the bushing of interest; if, for example, the bushing of interest had a central void of square cross-section, a collet of square cross-section could and would be used.

Additionally, whereas wireless communication between the measurement tool and the data handling tool is contemplated, this is not strictly necessary: these tools could, by way of example, only, communicate by fixed link, or be integrated into a single unit, or carry a memory that is downloadable to the data handling tool.

Similarly, whereas the data handling tool is indicated to be coupled to the lathe by the Internet, this is also not necessary: others forms of coupling, such as Ethernet, etc., are possible, and the data handling tool and the lathe can be integrated into a single unit.

Further, whereas it is contemplated that the probe of the lathe will automatically measure and relay data to the data handling tool, it will be appreciated by persons of ordinary skill that this step could also be done, albeit less efficiently, by a human operator. If this were done, the human operator would ideally at least be provided with an electronic measurement device coupled for direct relay of data to the data handling tool, to minimize reading and transcription errors.

As well, whereas the workpieces [i.e. oversized bushings] are indicated in the exemplary embodiment to have substantially annular exterior surfaces, it will be appreciated that providing an annular surface is done only for convenience, speed and safety in machining, and is not strictly necessary.

Further, whereas in the disclosure, it is mentioned that the oversized bushings have internal diameters substantially identical to the bushings which they replace, it should be understood that, in the context of bushings which are required to be coated or plated, that the internal diameter of the oversized bushing is such that, once coated or plated, the internal diameter of the coated, newly-machined bushing, is that internal diameter required for proper functioning.

As well, whereas it is contemplated that oversized bushings will be used to produce custom-machined bushings in situations wherein the bore associated with said each removed bushing differs from that of the bore as originally manufactured, it will be understood that this contemplates material differences, i.e. microscopic changes to the bore diameter in the landing gear flowing, for example, simply from bushing exchange, would not necessarily require the use of a custom bushing.

Further, whereas it is contemplated that the present invention would be used for all of the bushings of an aircraft landing gear, this is of course, not strictly required. If, for example, the repair facility split responsibility for a particular gear amongst several sub-facilities for whatever reason, the present invention could be used by any one or more of those sub-facilities.

Finally, whereas a specific type of collet is shown and described, it will be understood by persons of ordinary skill in the art that expandable collets can be produced in numerous ways, and the invention extends to all such embodiments: the specific mechanisms shown herein are exemplary, only.

Accordingly, the invention should be understood as limited only by the claims appended hereto, purposively construed.

1. A method for manufacturing a part, the method being for use with a lathe and comprising the steps of:
making an arrangement of (i) an expanding collet which is operatively mounted on said lathe and disposed in a rest configuration and (ii) a workpiece in which a void is formed and which has a substantially annular outer surface, the arrangement being such that the collet is received by the void and the workpiece being shaped and dimensioned such that, in the arrangement, the collet is received by the void in a clearance fit relation and the rotational axis of the lathe is substantially coaxial with the annular outer surface of the workpiece;
expanding the collet to an operating configuration in which the collet engages said workpiece in gripping relation;
machining said workpiece into said part, using the lathe; and
collapsing the collet to the rest configuration, to enable removal of said part from the collet.

2. A method for manufacturing a part selected from a plurality of types, the method being for use with a lathe and comprising the steps of:
selecting, from a supply of workpieces, a workpiece of a type that is associated with the type of part selected, the workpiece having a void and a substantially annular outer surface; and
using the lathe, machining the selected workpiece into the selected part, the workpiece, during the machining step, being mounted to the lathe by a collet associated with the type of part selected,
wherein the collet is an expanding collet which, during machining, is received by the void and engages the workpiece in gripping relation.

3. A method according to claim 2, wherein the collet has
an expanded operating configuration during machining; and
a collapsed rest configuration, to enable removal of said part after machining.

4. A method according to claim 3, wherein a plurality of expanding collets is provided.

5. A method according to claim 4, wherein each of the expanding collets has a functionally identical mounting boss to facilitate interchange on the lathe.

6. A system for producing replacement bushings for a landing gear using a lathe, each bushing having an associated bore in the landing gear and, when originally manufactured, being classifiable, by its dimensions, into one of a plurality of bushing types, each bushing type having a central void, a nominal external diameter and a flange thickness, the system comprising:
oversized bushings, each oversized bushing being for replacement of one or more of the bushing types to be replaced using the system, said each oversized bushing having a central void shaped and dimensioned substantially identical to that of each of said one or more bushing types, a nominal external diameter larger than that of each of said one or more bushing types and a flange thickness larger than that of each of said one or more bushing types; and
a plurality of expanding collets, each expanding collet being provided for use with one or more of said bushing types and, in use, being mounted on said lathe and disposed in gripping relation within the void of one of the oversized bushings, with the rotational axis of the lathe substantially coaxial with the axis of the oversized bushing.

7. A system according to claim 6, wherein the central voids of the oversized bushings are annular.

8. A system according to claim 6, further comprising facsimile bushings, each facsimile bushing being for replacement of one of the bushing types to be replaced using the system, each facsimile bushing having nominal internal and external diameters and flange thicknesses functionally similar to those of said one bushing type but otherwise different.

9. A method using a lathe and the system of claim 8, the method being for producing replacement bushings for a landing gear wherein each of the bushings to be replaced have been removed from the landing gear and the associated bores reconditioned as necessary, the method comprising the steps of:
in circumstances wherein the dimensions of the bore associated with said each removed bushing remain as originally manufactured, using one of the facsimile bushings provided for the type of said each removed bushing; and
in circumstances wherein the dimensions of the bore associated with said each removed bushing differ from those as originally manufactured,
operatively mounting, to said lathe, one of the oversized bushings provided for replacement of type of said each removed bushing, the mounting being done through the use of the collet provided for the type of said each removed bushing; and
machining the oversized bushing mounted on said lathe to fit operably in the bore associated with said each removed bushing.

10. A method using a lathe and the system of claim 6, the method being for producing replacement bushings for a landing gear wherein each of the bushings to be replaced have been removed from the landing gear and the associated bores reconditioned as necessary, the method comprising the steps of:
operatively mounting, to said lathe, one of the oversized bushings provided for replacement of type of said each removed bushing, the mounting being done through the use of the collet provided for the type of said each removed bushing; and
machining the oversized bushing mounted on said lathe to fit operably in the bore associated with said each removed bushing.

11. Use of the method of claim 5 for manufacturing bushings for aircraft landing gear.

12. Use according to claim 11, wherein the workpiece is an oversized bushing.

13. Use according to claim 11, wherein the workpiece is a partially-machined bushing.

14. Aircraft landing gear bushings made by the method of claim 5.

15. A system according to claim 6, further comprising:
a CNC lathe with a dimensional measurement tool;
a data handling tool coupled to the lathe to permit passage of data and instructions; and
an electronic measurement device coupled to the data handling tool to permit passage of data therebetween.

16. A method using the system of claim 15, the method being for producing replacement bushings for a landing gear wherein each of the bushings to be replaced have been removed from the landing gear and the associated bores reconditioned as necessary, the method comprising the steps of, for each bushing:
at least in circumstances wherein the dimensions of the bore associated with said each removed bushing differ from those as originally manufactured,
measuring the dimension of the bore with the electronic measurement device;
operatively mounting, to said lathe, one of the oversized bushings provided for replacement of the type of said each removed bushing, the mounting being done through the use of the collet provided for the type of said each removed bushing; and
machining the oversized bushing mounted on said lathe to fit operably in the bore associated with said each removed bushing.

17. A method according to claim 16, wherein the data handling tool automatically:
causes the display to the lathe operator of information used by the lathe operator to select the collet and the oversized bushing;
calculates the required machined dimensions of the bushing based on the measured dimensions of the bore, predetermined interference requirements and predetermined coating thickness; and
relays to the lathe the required dimensions.

18. A method according to claim 17, wherein the lathe automatically machines the oversized bushing according to a protocol calculated to result in the required dimensions.

19. A method according to claim 18, wherein, prior to machining, the dimensional measurement tool automatically measures the dimensions of the collet and oversized bushing to permit the operator to effect replacement in the event that an error was made by the operator in the course of selection.

20. A method according to claim 19, wherein, following machining:
the dimensional measurement tool automatically measures the dimensions of the machined bushing;
the measured dimensions are automatically compared against the required dimensions;
the data handling tool offers the opportunity to the operator to offset the lathe an amount calculated to reduce the differentials between required and measured dimensions to nil; and
in the event that the comparison is reflected in measured dimensions that are outside predetermined tolerance and in excess of required dimensions, the lathe, after offset has occurred, automatically carries out a machining operation according to a protocol calculated to result in the required dimensions.
